(19) United States
(12) Patent Application Publication
(10) Pub. No.: US 2007/0118592 A1
(43) Pub. Date: May 24, 2007

(54) Method for the transmission of additional information in a communication system, exchange device and user station

(75) Inventor: Michael Bachenberg, Duesseldorf (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Pixcall GmbH, Duesseldorf (DE)

(21) Appl. No.: 10/566,377

(22) PCT Filed: Jul. 24, 2004
(86) PCT No.: PCT/DE04/01664

§ 371 Date: Jan. 26, 2006

(51) Int. Cl. G06F 15/16

(52) U.S. Cl. 709/203; 725/74

(57) ABSTRACT

The invention relates to a method for the transmission of additional information in a communication system (10), whereby a communication context connection (15a, 15b) is established from a first user station (11) to at least one second user station (12), for the transmission of information and/or data. Additional information is thus transmitted from an additional information device (14) to the second user station (12). The transmission occurs in a signal for the establishment of the communication context in a defined format, in order to permit a representation as electronic data card or ID card with text, image or multimedia content before the call reception. The transmission occurs, for example, depending on a release of the first user station (11) for the receipt of additional information. Query data are sent, for example, before the transmission. A selection can be carried out by means of a pre-selection or an additional code.

The present invention relates to a method for the transmission of additional information in a communication system according to the introductory portion of claim 1, an exchange device for a communication system according to the introductory portion of claim 22, a user station for a communication system according to the introductory portion of claim 36, and a control program.

In communication systems such as those in mobile radio networks or cable-bound networks, speech and data are transmitted between user stations. Such communication systems include, for example, the Internet, cellular mobile radio networks, cabled telephone networks, or even combinations of several types of communication networks.

An example of a cellular digital radio network is the GSM mobile radio network (Global System for Mobile Communication), which is suitable for speech and data transmission. Here, mobile user stations are connected by aerial interfaces to a radio transmission system. An exchange system, in most cases with several mobile exchange points and associated visitor registers, serves to transmit signals and data derived from a user station specifically to a desired further user station and to establish the corresponding connection.

The publication WO 9521508 A1 discloses a method for packet data transmission in a mobile radio network, whereby individual data packets are transmitted in traffic channels between mobile radio stations and base stations within a data packet service, namely the GPRS or General Packed Radio Service. In this system existing mobile radio networks may also be widely used for packet data transmission. Here, the participating mobile station is allocated a code number by which the traffic channels are identified in control channels as traffic channels containing at least one data packet.

In communication systems, and particularly in modern mobile radio systems, there is an increasing requirement for further expansion of data transmission so that even relatively large data packets, which contain image, audio or video data, for example, can be exchanged quickly between individual user stations of the communication network.

For reducing the signalling load during the transmission of data packets in data transmission in a mobile radio network, the publication DE 19524659 C1 discloses a method for transmitting data packets within a packet data service in which a channel is reserved in the radio transmission system of the mobile radio network, and is linked to a continuous data channel with a transmission channel which leads to a separate services network node.

As a result of the further development of the cellular mobile transmission methods, more and more possibilities are being created for rapid data transmission, even between mobile user stations. An example of this is the UMTS method (Universal Mobile Telecommunication System), which is also ideal for the transmission of multimedia data between user stations of any kind, for example mobile radio sets, PDA's (Personal Digital System), PC, workstation or laptop computers, etc.

For reducing the costs for the subscribers or users, adverts can be transmitted to the users stations. For example, advertising in the form of advertising banners, short films or logos may appear on the displays of users who in return receive a cost reduction for the use of the mobile phone network.

In this context the document DE 10150106 A1 discloses a device and a method for the transmission of information, whereby a user or subscriber is assigned to a group of users or subscribers and the same information is transmitted to all users of a certain group. Consequently the load of common connection paths shall be reduced and additional capacities for the transmission of advertising shall be provided to a service supplier.

The laid-open specification DE 10137677 A1 describes a data communication system for the automatic planning of advertising campaigns. Here, target group data relating to a particular target group shall be entered at an input/output device, as well as price data relating to the price of the advertising campaign.

In the laid-open specification DE 10161162 A1 a method for displaying advertising on a display of mobile communication terminals is described, in which advertising data are received via the wireless Internet network and compared with advertising data stored in a memory of a mobile communication terminal, in order to update the received advertising data in this way. When the mobile communication terminal is activated, the advertising data are indicated on the display of the mobile communication terminal.

A further method for feeding in advertising is known from the document DE 19709937 A1. Here, the call status of the calling subscriber and the call status of the called subscriber are determined and a message signal source is connected to the line of the calling subscriber until the called subscriber takes off the phone.

To enable additional information in form of advertising data to be recorded in a telecommunication system comprising a first communication network and a second connection network, the laid-open specification DE 19940400 A1 discloses a method and a device for the transmission of additional information to user stations of a connection network, in which an additional information device in a connection network establishes an additional communication connection to a calling user to transmit advertising data there.

However, the known methods and systems suffer from the disadvantage that the recipient does not sufficiently visually detect the adverts or additional information, because the users receive the advertising either in the form of speech messages prior to the desired connection or during an interruption of connections. Furthermore, this kind of adverts is often perceived as disruptive or annoying, or the perception is intentionally suppressed on the user side so that the object of the advert is not achieved in many cases. In addition, the advantage of a cost reduction is in many cases not sufficient to accept such adverts.

A further problem is that adverts shall usually only be transmitted with the consent of the recipient or in the context of existing relationships between the sender and the recipient. In order to solve this problem, a previous clearance to receive adverts was suggested in some cases, the clearance resulting in specific benefits or cost benefits for the costumer during the communication. However, the disadvantage of this solution is that the clearance procedure is an obstacle for the user to start making use. The result of this is that the subscribers slowly make use of such a service and the service is slowly spread in the market. On the other hand an effective protection against unwished or even bothering advertising is necessary for the client of a mobile radio company or subscriber of a communication network.

In addition, many existing terminal devices are not capable to send multimedia information. Furthermore, sending multimedia information is not only related to high costs but in most cases is also related a complicated operation by the user which prevents potential users from using such services. However, in particular in the mobile radio sector there is a need for sending multimedia information in a simple and attractive way.

It is the object of the present invention to provide a method for the transmission of additional information in a communication system, which on the one hand saves costs for the data transmission and on the other hand allows to specifically and effectively place adverts or other data which can be perceived in a positive fashion, whereby in return the user receives an attractive advantage. Furthermore, an exchange device for a communication system and a user station for a communication system shall be provided, with which the above-mentioned advantages can be achieved and the method according to the present invention can be performed.

This object is achieved by the method for the transmission of additional information according to claim 1, by the exchange device for a communication system according to claim 22, by the user station according to claim 36, and by the control program according to claim 37 and 38. Further advantageous features, aspects and details of the invention are apparent from the dependent claims, the description and the drawings.

In the method according to the invention for the transmission of additional information in a communication system, a communication context is established from a first user station to at least one second user station in order to transmit information or data to the second user station, and depending on a signal of the first user station for setting up the communication context, additional information is transmitted from an additional information device to the second user station, whereby the data of the first user station and/or the additional information within the signal for setting up the communication context is transmitted to the second user station in a defined format in order to allow there a representation as a data card with text and image content before the call is accepted.

Because the second user who receives the call also receives the additional information triggered by the call, he perceives visually on his display and/or in an audible form the additional information, even if he does not accept the call. Because the advert is linked to receiving a call, an increased awareness and a positive expectation of the called user is produced resulting in a positive attitude with respect to the received additional information. As a result, the additional information or advert achieves a better perception and an increased effectiveness. In return the subscriber receiving the advert has the possibility, in accordance with the mobile radio network operator or service provider or also the advertiser, to send data or data packets, in particular multimedia data, or even to send such data free of charge. The users receive an attractive advantage which results in the dissemination of the method and thus contributes to a further cost reduction.

Moreover, advertising can be placed target-specifically, exactly be measured and settled, and have a high advertising effect. Multimedia advertising is rendered possible at the users stations in particular of mobile communication systems. Consequently visual or multimedia information can be transmitted in a simple way at low costs financed by advertising, and a high number of existing terminal devices can be used without relevant modifications of the software or hardware. Furthermore, a specific control of the adverts depending on the target groups may take place, because the called or second user can be identified and specifically provided with additional information, depending on his affiliation to a target group.

For example, by a selection function exists the possibility that the user may select without any restriction whether he would like to receive additional information from a separate additional information device when a call is received, and in return, for example, receive benefits related to the use of the communication system, in particular in the form of reductions, free data transmissions, free connection minutes or other privileges.

In particular, the privilege may be that the user himself may generate data packets or multimedia data at his user station and send it to other users, free of charge or at reduced fees, for example.

Furthermore, there is a selection possibility with respect to the type of the received additional information, for example according to the personal interests of the user depending on data stored in connection with the user.

The additional information may be linked to a user identification of the first or second user station in the context set-up or call set-up signal of the first user station. As a result, the additional information is connected to the signal during set-up of the call or connection, and is transmitted to the called user. The additional information is perceived even if the called user denies the connection.

The additional information and the user identification of the first or second user station can be transmitted to the second user station as at least one common or linked-together data packet. This contributes to an increased capacity during the transmission of information.

Advantageously, the data provided by the first user station for transmission contain text, image, video and/or audio data. This means that they may comprise a combination of different types of data, in particular multimedia data. In particular, the data at the first user station can be generated and sent depending on whether this user station on its part accepts to receive additional information.

The data provided by the first user station for transmission are preferably displayed and/or stored at the first and/or second user station in the form of individual ID cards or electronic data cards. As a result, a large number of clearly arranged packets of multimedia data or data sets, each having at least one display page, for example, can be generated, edited, stored, and sent at/from the user station.

It is also possible, for example, to store ID cards in the database of the provider so that the memory of the terminal device is not overloaded. The ID cards are checked at the server with each outgoing call and attached to the caller ID or user identification if the ID card is existent for the called number.

The data provided by the first user station for transmission, in particular in the form of ID cards or data cards or data packets, are preferably assigned to or can be assigned to at least one stored or dialled caller identification of a user station. Consequently the user of the user station may simply and quickly send a data card to one or more other user stations, or he may send the corresponding data card at the same time with a speech or text message.

The second user who receives such a call with a data card receives simultaneously with the incoming call, for example, the ID card or data card of the calling user station. As a result, individual information of the calling user or subscriber can be received and displayed before the call is accepted or before the complete connection is established.

Preferably, the data provided at the first user station for transmission in form of at least one general data packet may also be assigned to a large number of call identifications of user stations, or stored generally for the transmission to users who do not have an ID card assigned. As a result, it is possible to attach a personal message to all outgoing connections, for example.

Preferably, the data provided at the first user station are previously generated in the first user station. As a result, an individual modification and generation according to the wishes of the user is possible.

The data provided by the first user station can be loaded into a memory of the first terminal device prior to sending, for example. Thereby it is possible to generate data or ID cards at an external device such as a computer or personal computer, and subsequently send them as an ID card, for example, from a mobile user station such as a cellular phone or generally from a telephone, PDA, or similar device.

The transmission of additional information preferably takes place depending on a clearance of the second user station as a selection function for the receipt of additional information. This means that only user stations, which are activated to receive additional information receive additional information such as adverts. If they are not activated for this, they are nevertheless able to receive incoming data, in particular ID cards from other user stations, however they cannot send or generate such data themselves, according to a preferred embodiment of the invention.

For example, the clearance may take place for one or more specific types of additional information to be received. As a result, the additional information can be adjusted individually with respect to the recipient. Besides adverts also specific types of messages or other information can for example be transmitted when a call is coming in, for example information on particular entertainment offers within the geographic region of the mobile user station.

In the additional information device, user specific additional information can particularly be selected from a variety of additional information and transmitted to the second user station, depending on the subscriber information of the second user station. Thus, adverts or other messages or news can be tuned directly to the recipient of a call.

The additional information preferably comprises adverts in the form of text, image, video and/or audio data. Thus, in particular multimedia data are sent as adverts to the recipient of a call.

The data to be transmitted is preferably transmitted depending on a clearance of a first user station to receive additional information. Therefore a user may transmit data or multimedia data, in particular ID cards, to other users, provided that he is ready to receive additional information.

The additional information is advantageously indicated on the display of the second user station alternately or cyclically with the data which are transmitted from the first user station. Thereby ID cards and additional information can be displayed at the same time or equally.

The additional information is preferably still indicated on the display of the second user station even if the connection has been terminated, and there it takes over the function of a screen saver for the display.

The data provided by the first user station and/or the additional information are advantageously already received at the second user station when the connection is set up and prior to acceptance of the call. Thus, there will be no fees for the connection.

The additional information device is preferably activated by a context set-up signal or connection set-up signal of the first user station in order to transmit the additional information to the second user station.

Advantageously, after the transmission of the data from the first user station and/or of the additional information, the information, which is originally intended to be displayed at the second user station is replaced by the transmitted data and/or by the additional information. As a result, new adverts or other messages in particular in the form of multimedia data can be positioned on the display of the recipient again and again.

In a particular embodiment the additional information comprises audio data, which are stored in the second user station as a signal tone for future incoming connections. Thereby up to date ring tones, for example in the form of music, can be loaded into the second user station, for example. By offering up to date music, which can also be stored as ring tones or call signal tones, for example, the positive readiness to receive and observe advertising can further be increased. Also specific pieces of music or tone sequences can be transmitted as a carrier of adverts and become permanently effective at the recipient.

For example, it is also possible to override or to cover or to temporarily replace the ring tone, which is chosen at the terminal device of the call recipient by ring tones, which are sent together with the advertising. This means that an override function is provided for example. In this case it is not necessary that the ring tone is to be stored. For this purpose, a melody generator is preferably provided in the terminal, which generator receives the data for generating the ring tone together with the caller ID or subscriber identification, the ID card and the additional information or advertising data packet.

The additional information is preferably linked to text or image messages or to multimedia data going out from the first user station. As a result, a more effective data transmission and higher capacities are achieved.

Advantageously, the transmitted data and/or additional information is/are stored in a memory allocated to the second user station and/or displayed at the second user station when a call is not accepted. Consequently the data of a caller or the additional information can be displayed or reproduced permanently.

A network operator, provider or a roaming partner, can carry out the transmission of additional information for each call. For example, the additional information is connected at the network operator of the first user station or at the network operator of the second user station. Thus, a higher flexibility with respect to the addition of information, in particular advertising, is achieved.

Preferably, the method according to the present invention uses the UMTS standards. Thus, an effective use of the provided UMTS technology will be possible thereby reducing the relatively high costs of this technology for each single user.

For example, fee reduction data are generated depending on the type and/or the duration of the indication of the received additional information, and stored in a charge reduction memory. Thus, a particularly exact charge reduction can be granted to the respective user station. Furthermore, the costs of the advertising can be calculated depending on the type and duration of the reproduction. In particular, the data to be transmitted can be transmitted at reduced fees or free of charge by the first user station, depending on a clearance to receive additional information.

It is a particular advantage to send query data from the additional information device to at least one of the user stations prior to the transmission of the additional information, whereby the additional information is displayed at the second user station depending on a response signal of the respective user station. Thus, a protection against Spam or unwanted advertising is achieved, whereas on the other hand the subscribers are enabled to have an easy access to benefits by means of the addition of advertising or other additional information.

The user is widely protected against unwanted advertising but may nevertheless effect the indication of additional information without a previous clearance, if he wishes to do so. Thus, the users may spontaneously and directly be addressed with advertising as additional information, and on the other hand a protection against annoying advertising is achieved. For example, by the invention also legal regulations can be easier observed and charge reduction systems, which are based on the acceptance of the respective user for receiving advertising, can more easily and faster be applied and introduced to the market.

Preferably, the query data are sent to the second user station and designed to determine or to inquire whether the second user station accepts receiving additional information, the additional information being displayed or not displayed depending on the response signal of the second user station.

Thereby, additional information such as advertising is only displayed at the second user station or at the recipient of a call and transmitted there, if he agrees to this, wherein the consent can be declared instantaneously and directly in connection with the incoming call. If the recipient of a call receives for example a SMS or MMS message from the first user station, he may be asked before it is displayed whether he would like to see advertising, if necessary together with the offer to receive a fee reduction or another benefit. As a result, unwanted advertising or Spam does not bother the call recipient.

According to a particularly preferred embodiment the query data contain a selection of additional information models, which are transmitted from the additional information device to the first user station, whereby one of the additional information models is selectable at the first user station as an additional information for transmission to the second user station and the response signal of the first user station contains an information on the selected additional information model.

Consequently, adverts personally selected by a user can be transmitted to another user, for example to recommend a particular film or to draw attention to a specific product, which is likely to be of interest for the called user. In this case it is also possible, for example, to immediately address new users or subscribers who would like to participate in a fee reduction system based on advertising. In particular, a dissemination loss of adverts is minimised and the advert is not perceived anonymously but as a personal recommendation.

The selectable or selected additional information model is preferably linked with a field for entering subject information at the first user station. Thereby the additional information, which is for example an advert, can be complemented by personal messages of the caller and thus personalised, before it is sent to the call recipient. As a result, the additional information becomes a personal message of the caller, for example in the form of a personal recommendation.

Preferably, the query data are indicated on an additional display. Thereby a particularly user-friendly guidance of the user is achieved, which allows an easy and fast response of the user to the received the query data.

Preferably, the response signal of the respective user station, in particular of the second user station, effects a general clearance for the receipt of additional information during future communication connections. Thus, a short term and fast membership of the user or call recipient at specific communication services is achieved, which communication services offer particular benefits to the user, for example, by the addition of advertising. These benefits may be e.g. cost advantages or the possibility to transmit data, in particular multimedia data. In the case of the prior clearance it is not necessary during future communication connections to send an inquiry to the user whether he would like to receive additional information.

Prior to sending the query data, the additional information device can for example check whether the second user station is generally activated for the receipt of additional information, whereby the query data will be transmitted or not transmitted to the second user station in particular depending on the result of the test.

If a clearance already exists, the additional information can be directly transmitted to the second user station, without the necessity to transmit query data before.

The information sent by the first user station preferably comprises short messages, SMS, SMS, MMS, speech, text, image, audio, video and/or other data or multimedia data, whereby depending on the willingness of the second user station to display additional information, for example, the information can be transmitted partly or entirely.

For example, the caller may send a data set with image, video or other multimedia data to the second user station, for example a message in the form of a personalised data set, which for example contains address data of a caller with an image of the caller and which can be displayed as a data card at the user stations. This electronic data card of the caller, herein also called ID card, is for example at the beginning only partly displayed at the second user station, or the incoming ID card will only be announced by the query data. If the second user station is ready to receive additional information, in particular advertising, by sending the respective response signal or by a clearance that has already been made, the complete ID card of the caller will be indicated at the second user station. This indication may, for example, alternate with the additional information or advert.

Furthermore, the information sent by the first user station may comprise short messages, speech, text, image, audio, video and/or other data or multimedia data, whereby depending on the acceptance or corresponding readiness data of the first user station to receive additional information, the information is partly or entirely transmitted.

In this case, the ID cards or other data or multimedia data can be sent by a user only in the case, for example, if he is activated to receive additional information.

Advantageously, fee reduction data will be generated or communication connections at reduced costs or communication connections with improved service characteristics will be provided for a user station, depending on the response signal.

As a result of this the user can instantaneously make use of particular services for the future by means of a corresponding response signal, which particular services offer the possibility, for example, to send own ID cards or address data, personal data and/or images in the corresponding format to another user or subscriber.

For example, it is possible to transmit the information or data at reduced costs to the second user station, depending on the clearance of the first user station to receive additional information. As a result, the user may fully or partly finance the sending of his data or ID cards by adverts.

Advantageously, the transmission of additional information from the additional information device to the second user station is effected by an additional code, which is connected at the first user station to a station or caller identification of the second user station.

By activating the transmission of additional information by means of an additional code, in order to send the additional information from an additional information device to a call recipient, information in a multimedia form can be sent to a selected subscriber in a simple and cost effective manner, whereby a high number of already existing mobile terminal devices or user stations can be used. Essential modifications of the software or hardware of the terminal devices or user stations are not necessary. Thus, a fast acceptance and market penetration can be achieved.

The additional information for example can comprise advertising or general information. However, it may also be personalised or individual messages previously stored in the additional information device, for example via the Internet. The user for example may configure the additional information individually. It can contain images, audio and video information, and after storage it can be retrieved and sent to the call recipient by means of the prefix.

The additional code is preferably generated by entering or retrieving a specific prefix at the first user station, which prefix is dialled before the call identification of the second user station when the communication connection is set up. Thus, the user at the first user station can for example simply select a prefix prior to the phone number of the called user or the second user station, in order to transmit to the call recipient multimedia information or additional information, for example.

For example, in a communication network in which a large number of user stations are interconnected, the additional code or prefix effects that the additional information is transmitted to the call recipient within the signal for setting up the communication context or within the call set-up. As a result, additional information can already appear prior to acceptance of the call at the second user station, for example as a multimedia, graphic or audio visual call signal.

Preferably, at least one such additional or prefix code is stored in a user memory and for example allocated to one or more call identifications of user stations, which call identifications constitute electronic telephone directory entries. Thereby the user at the first user station can easily set in advance that particular telephone directory entries are always bound to a transmission of additional information.

Advantageously, the additional information device transmits additional information selected from a large number of different additional information to the second user station, depending on the additional code. Thus, for example, personalised advertising or advertising adjusted to the recipient or information can reach the recipient. This means that the recipient receives only such information, for example, which corresponds to his estimated interest profile. Thereby the caller has the possibility, for example, to specifically select general information, specific information of the caller or advertising for the recipient, which he knows personally in most cases.

For example, the additional code can be positioned on products or billboards, or it can be shown in information media. Thus, a user can select this specific number as a prefix before the phone number of the call recipient, whereby the prefix triggers or controls a predefined content which is transmitted as additional information in the form of advertising or other information to the call recipient. For example, a company can provide an individual code number on its products, which enables a user to use one or more times a specific communication service, as for example the transmission of multimedia data to other users. As a further advantage, programs for binding customers can be realised. The buyer of a product provided with a particular code number as a prefix, can for example receive a benefit when he uses that prefix.

The additional information preferably comprises text, video, audio and/or multimedia data in a defined data format so that it can be graphically displayed on the second user station in the form of individual electronic data cards. Thus, it is possible to send additional information as electronic multimedia cards or business cards and to display it on the second user station. However, it is also possible, for example, to send information of this type directly from the first user station to the second user station.

The additional information may in particular comprise data in the form of data packets, each of them being assigned or assignable to at least one saved or dialled call identification of a user station.

Advantageously, the transmission of additional information depends on a clearance of the second user station to receive additional information. Thereby it can be assured that only such user who has generally agreed to receive additional information receives additional information. As a result, he may receive in return charge benefits, bonus points or other advantages or particular communication services, as for example the possibility to send multimedia information or data cards. At the same time a Spam protection or protection against unwanted advertising is achieved.

Preferably, the transmission of additional information depends on a clearance of the first user station for the receipt of additional information. Thereby, a subscriber can self determine, whether he would like to receive additional information and in return for this receive the benefit to send additional information to other subscribers.

Query data are advantageously sent to the second user station prior to the transmission of additional information, and the additional information is displayed or not displayed at the second user station depending on a response signal of the second user station in response to the query data. Thus, effective Spam protection is achieved, without the need of a previous clearance. As a result, each user can immediately and directly decide whether he would like to use the benefits of the communication method. Through the omission of a previous clearance, which is often time-consuming or needs a particular action of the user, a faster acceptance of the method or system and a quicker market penetration can be achieved.

Preferably, different types of additional information are indicated alternately or cyclically on the display of the second user station. Thus, for example, personal multimedia information of a caller can be displayed alternately with adverts.

Advantageously, the additional information is indicated on a display of the second user station after termination of the connection, and there it takes over the function of a screen saver until the next call comes in, for example. As a result, advertising, graphically appealing information corresponding to the modern spirit of the time or also always up to date information can appear at the user station, whereby the user additionally receives a personal image by presenting his terminal device.

In particular, the additional information can already be received at the second user station during set-up of the connection and prior to acceptance of the call. As a result, the recipient views and/or hears the individual electronic multimedia data card of the caller, for example, and he can subsequently decide whether he accepts the call. However, for example, he can also regard advertising information and collect bonus point by accepting the call. Thus, advertising can be positively perceived and actively received.

For example, a bonus signal can be generated by the additional code, which bonus signal is assigned to the first user station and/or to the second user station, in order to assign a charge reduction information to the respective of user station. Thereby the respective user can for example collect bonus points which can be redeemed at a later time for example by means of his user station. Thus, each connection established via the additional code can be rewarded with bonus or loyalty points. The bonus points can be redeemed for example against free talk or communication units, ring tones, logos, etc.

The inventive exchange device is suitable for a communication system and comprises a switching unit for setting up a communication context between a first user station and at least one second user station in order to transmit information or data from the first user station to the second user station, and an additional information device for sending additional information to the second user station, whereby the exchange device effects the transmission of the data and/or the additional information to the second user station within the signal for setting up the communication context, such that a representation of the data as an individual data card of the first user station with text and image content is enabled at the second user station already prior to acceptance of the call.

By the exchange device according to the present invention, messages, in particular adverts, can be placed effectively and target-specifically, achieve a high degree of acceptance at the user, and moreover they can be settled exactly. Additionally the users are enabled to send individual data by themselves, without involving high costs. Furthermore, there exist the same advantages, which have been mentioned previously in connection with the method of the present invention.

Advantageously, the exchange device couples the additional information to the data stream outgoing from the first user station. In particular, this provides high capacities.

The device comprises in particular an additional information selection unit, which specifically selects additional information form a large number of additional information stored in an additional information memory, depending on the user identification number of the second user station, for transmitting the selected additional information to the second user. Thereby a particularly effective placement and positioning is achieved.

Preferably, a charging unit is provided, in which charge reduction data for a user station is registered depending on a clearance to receive additional information. Thereby the user receives an attractive monetary benefit.

Advantageously, a comparison unit is provided, which permits or prevents the generation, transmission and/or storage of multimedia data depending on a clearance of a user station to receive additional information. As a result, each user can freely choose, whether he would like to participate in the method and thus use the advantages. On the other hand he can nevertheless receive all information from other users, if he takes a decision against a clearance.

Advantageously, the additional information comprises data for indication on a display in the form of additional information data cards. Thus, the additional information can be supplied in the same data format, for example, as the data generated by the users, in particular in the previously mentioned ID card format.

Advantageously, a query unit for sending query data to at least one of the user stations is provided, as well as a selection circuit which effects the transmission of additional information to the second user station depending on a response signal of the respective user station in response to the query data.

Thereby the users are protected against unwanted advertising, and they can nevertheless directly participate in services financed by adverts, if they want this in each single case. It is also possible that callers finance the call by adverts in the single case. As a result, communication services financed by advertising will be quickly accepted and disseminated.

Preferably, the query data are sent to the second user station and are designed to determine whether the second user station is ready to receive additional information, whereby the selection unit can effect or prevent the transmission of additional information depending on the response signal of the second user station.

However, the query data can also contain a selection of additional information or advertising models which are transmitted to the first user station, whereby the selection circuit effects the transmission of an additional information model selected by the first user station to the second user station, depending on the response signal of the first user station.

In this case, the selected or selectable additional information model is preferably linked to a field for entering subject information at the first user station.

Advantageously, the selection unit comprises test means for determining whether the second user station is activated to receive additional information.

For example, the exchange device can partly or completely transmit the information sent by the first user station to the second user station, depending on the readiness to display additional information.

Preferably, a user memory is provided, for storing charge reduction data or available communication services for a user station depending on its readiness to display additional information.

Advantageously, the exchange device comprises a selection circuit, which transmits the additional information to the second user station depending on an additional code connected to the call identification of the second user station.

The method or communication method according to the present invention can be performed by means of the exchange device. The advantages and features mentioned in connection with the method according to the present invention are the same as those of the exchange device according to present invention and vice versa.

Preferably, the exchange device is part of a communication network with a large number of user stations, and it is for example designed to transmit the additional information within the call set-up signal to the second user station when the additional code is received.

Preferably, an additional information selection unit is provided which specifically selects additional information from a large number of additional information stored in an additional information memory, for transmitting the selected additional information to the second user station, whereby the selection depends on the additional code.

For example, depending on the additional code the selection unit generates a bonus signal, which allocates charge reduction information or other benefit information to the first and/or to the second user station.

In particular, the device according to the present invention is provided with means for performing the method according to the invention.

The inventive user station for a communication system comprises an interface to a communication network for connecting it to other user stations, a data memory for storing data comprising image, audio, video and/or multimedia data, a processor unit for the preparation of the data to display it in the form of data cards, and a display unit for indicating the data cards, wherein the processor unit is designed for processing the additional information received from the communication network and coupled with call data of the first user station, for displaying it in the form of data cards, and wherein a data card authorisation circuit permits or prevents the generation or sending of data cards depending on a clearance of the first user station to receive additional information.

Advantageously, a data card authorisation circuit is provided, which permits or prevents the generation and/or sending of the data card depending on a clearance of the user station to receive additional information. Thereby the user can decide whether he wants to receive advertising when a call or a message from a user is coming in, and in return to receive a benefit, as for example the possibility to generate and to send ID cards.

Preferably, the data cards within the data memory are or can be allocated to one or more call addresses of other user stations. Thus, the data can easily be edited, generated and specifically addressed transmitted.

Preferably, the additional information from the communication network can be displayed in the form of additional information data cards on a display. As a result, personal ID cards and additional information in the same format can be processed.

Advantageously, the additional information can be indicated alternately with the ID cards on the display. Thus, the additional information and also the personal data sets or ID cards can be displayed.

The processor unit preferably effects the indication of the additional information of the display until the user station is called again by another user station. Thus, the additional information can be displayed permanently on the user station.

Moreover, the display time can be measured in the exchange device, so that advertising can be settled exactly.

The inventive control program is suitable for a user station of a communication system and comprises the steps: receiving data and/or retrieving data from a memory, the data comprising at least one data set with image, audio, video, text and/or multimedia data; processing the data sets for indication on a display, the data set being displayable as a data card; and assigning the data set to one or more stored user identifications; wherein sending of at least one data set representing a data card to at least one further user station is performed, if a clearance parameter represents an existing clearance for the indication of additional information from a separate additional information device.

According to an additional aspect of the invention, a control program for a communication system is provided, wherein the communication system comprises a large number of user stations and an additional information device, and the control program comprises program steps for performing the inventive method.

The invention comprises in particular also the following aspects:
(A) A method for the transmission of additional information in a communication system, wherein a communication connection is set-up from a first user station to at least one second user station in order to transmit information and/or data from the first user station to the second user station, wherein additional information outgoing from an additional information device is transmitted, and wherein depending on a call set-up signal of the first user station and on a selection function which is valid for the second user station, the additional information is transmitted from the additional information device to the second user station during set-up or after establishment of the communication connection.
(B) A method or communication method with optional transmission of additional information to user stations of a communication system, wherein a communication connection is set-up from a first user station to at least one second user station in order to transmit information from the first user station to the second user station, wherein outgoing from an additional information device separate additional information can be sent to the second user station, and wherein query data are sent from the additional information device to at least one of the user stations, whereby the additional information is indicated at the second user station depending on a response signal of the respective user station in response to the query data.
(C) A method or communication method with activated transmission of additional information, wherein within a communication system, a communication connection is set-up from a first user station to at least one second user station, whereby outgoing from a separate additional information device, additional information is transmittable to the second user station, and whereby an additional code, which is connected at the first user station to a call identification of the second user station, effects the transmission of additional information from the additional information device to the second user station.
(D) An exchange device for a communication system comprising a switching unit, which generates a communication connection to a second user station when receiving a call set-up signal from a first user station, and an additional information device for supplying additional information for selected user stations, whereby a selection circuit is provided, which depending on a user identification contained in the call set-up signal of the first user station and on a clearance function of the second user station transmits the additional information to the second user station. The selection function is for example part of the additional information device.
(E) An exchange device with optional transmission of additional information to user stations of a communication system, comprising a switching unit for setting up a communication connection between a first user station and at least one second user station, in order to transmit information from the first user station to the second user station, and an additional information device for sending additional information to the second user station, whereby the additional information device comprises a query unit for sending query data to one of the user stations, as well as a selection circuit, which depending on a response signal of the respective user station in response to the query data effects the transmission of additional information to the second user station.
(F) An exchange device for a communication system, comprising a switching unit, which generates a communication connection to a second user station when receiving a call set-up signal from a first user station, and an additional information device for transmitting additional information to the second user station, wherein a selection circuit is provided, which depending on a additional code being added or pre-switched to the call identification of the second user station transmits the additional information to the second user station.
(G) A communication system with a variety of user stations which are or can be connected to a communication network via an interface, wherein the communication system comprises an exchange device according to the invention.
(H) A user station for a communication system, comprising an interface to a communication network for the connection with other user stations, a data memory for storing data comprising image, audio, video, text and/or multimedia data, a display for indicating the data, means for the transmission of the data via the interface, and a processor unit for processing and displaying the data in the form of data cards, whereby the processor unit is designed for processing and indicating additional information received from the communication network on the display.

The advantages and features mentioned in connection with the inventive method, the exchange device, the communication system, the user station, or the control program, or which are explained in detail in the following, are also valid for the respective other aspects of the invention, and vice versa.

The invention will be described in the following by means of examples with reference to the figures, whereby:

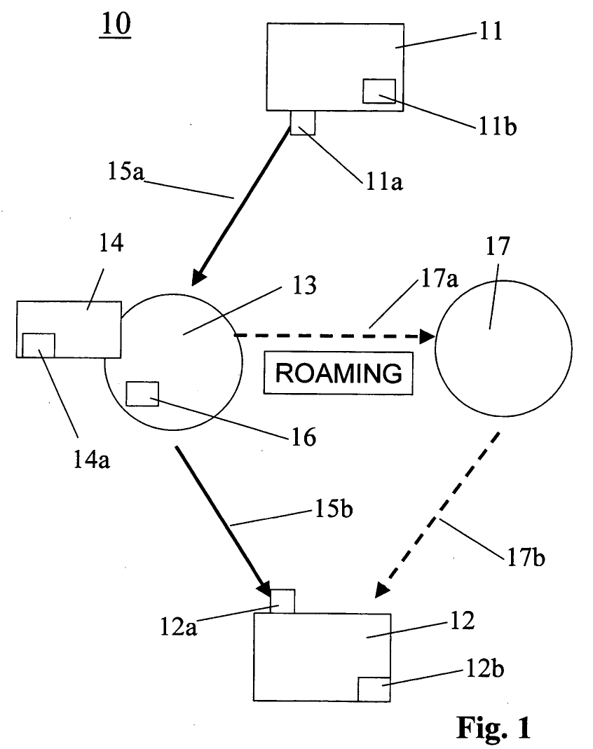

FIG. 1 schematically shows a communication system according to a first preferred embodiment of the invention, in which the inventive method is performed;

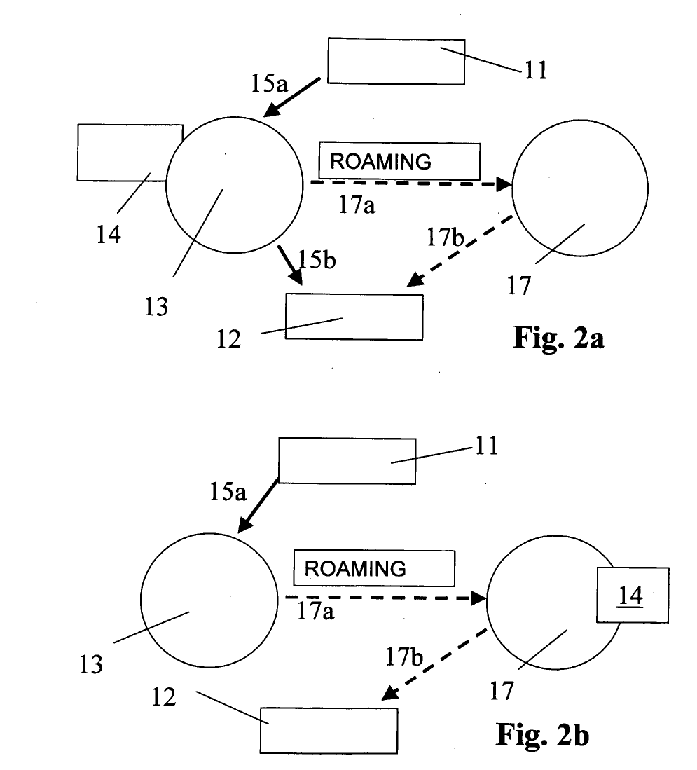

FIG. 2a schematically shows the generation of additional information in the communication network of a calling user, if both user stations belong to the same provider;

FIG. 2b schematically shows the generation of additional information in a communication network of a rooming partner, if both user stations belong to the same service provider;

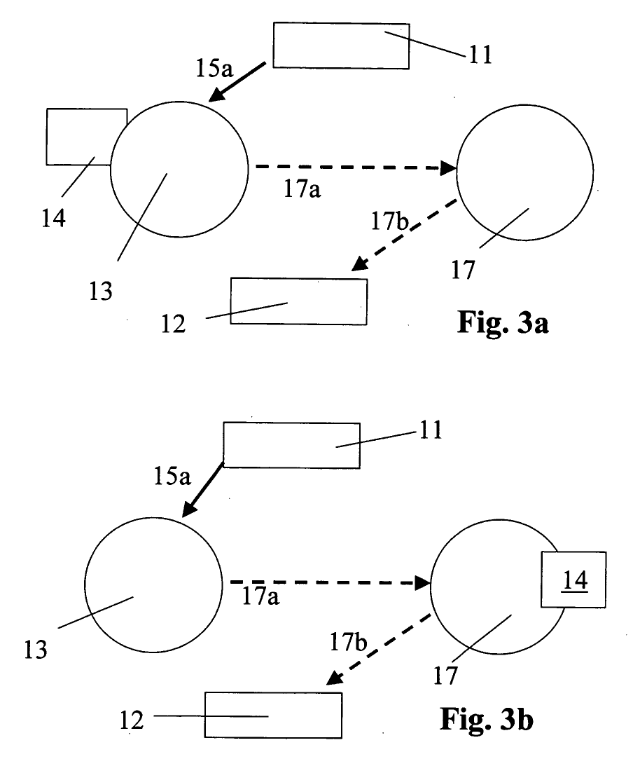

FIG. 3a schematically shows the generation of additional information in a communication network of a calling user, if both user stations belong to different providers and national calls are made;

FIG. 3b schematically shows the generation of additional information in the communication network of a called user, if both user stations belong to different providers and national calls are made;

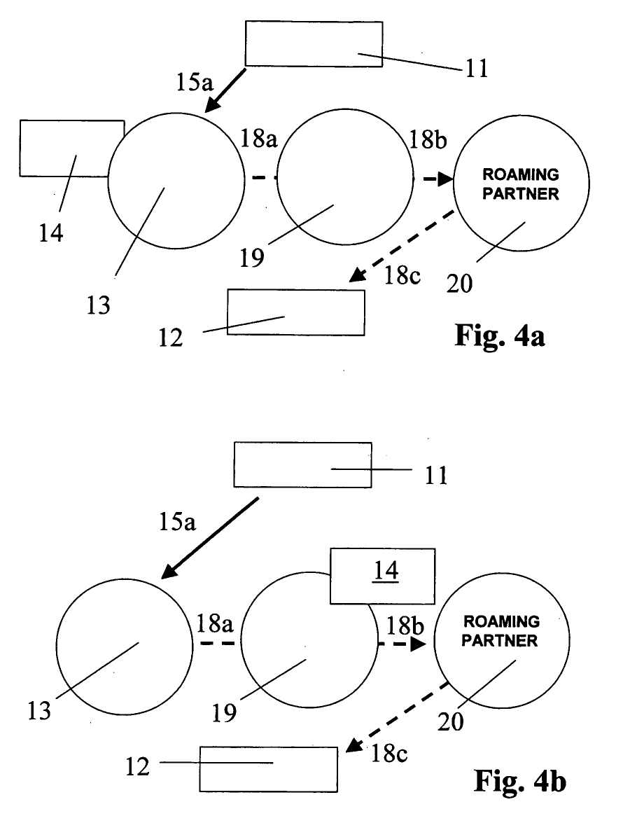

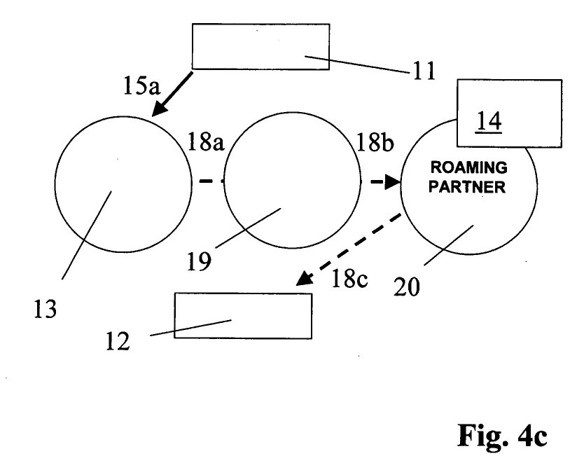

FIG. 4a schematically shows the generation of additional information in the communication network of a calling user, if both user stations belong to different providers and calls into foreign countries are made;

FIG. 4b schematically shows the generation of additional information in the communication network of a called user , if both user stations belong to different providers and calls into foreign countries are made;

FIG. 4c schematically shows the generation of additional information in a communication network of a rooming partner, if both user stations belong to different providers and calls into foreign countries are made;

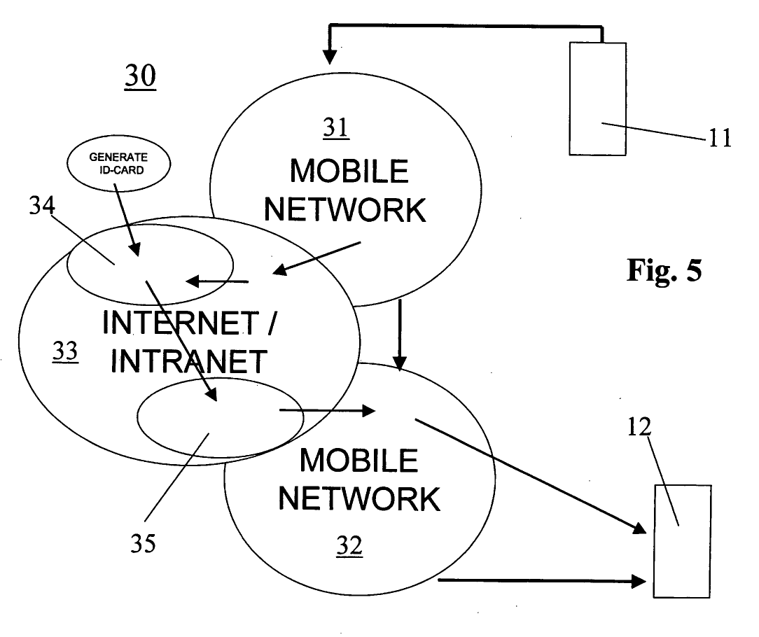

FIG. 5 schematically shows a communication system according to a second preferred embodiment of the invention, wherein the Internet and/or the intranet is part of the communication system;

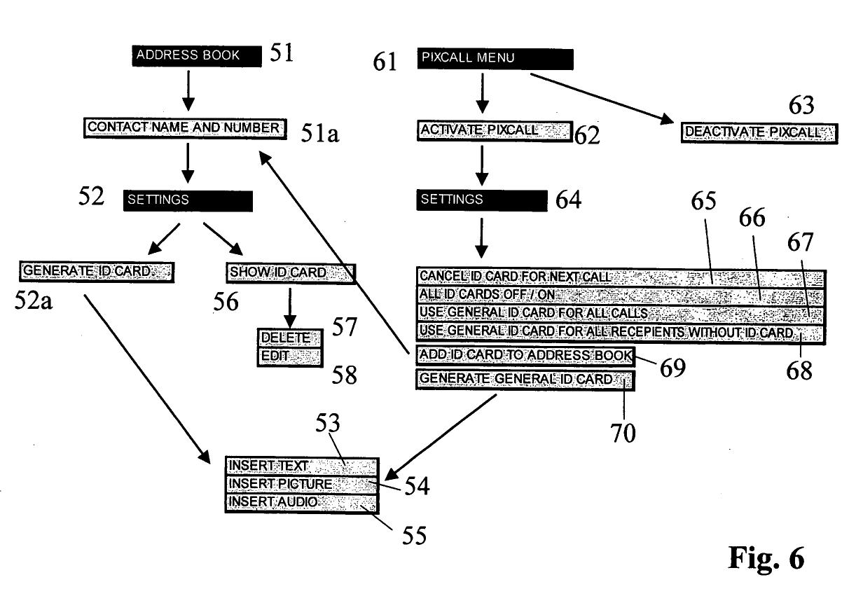

FIG. 6 schematically shows the operation process and corresponding menu commands on the display of a user station;

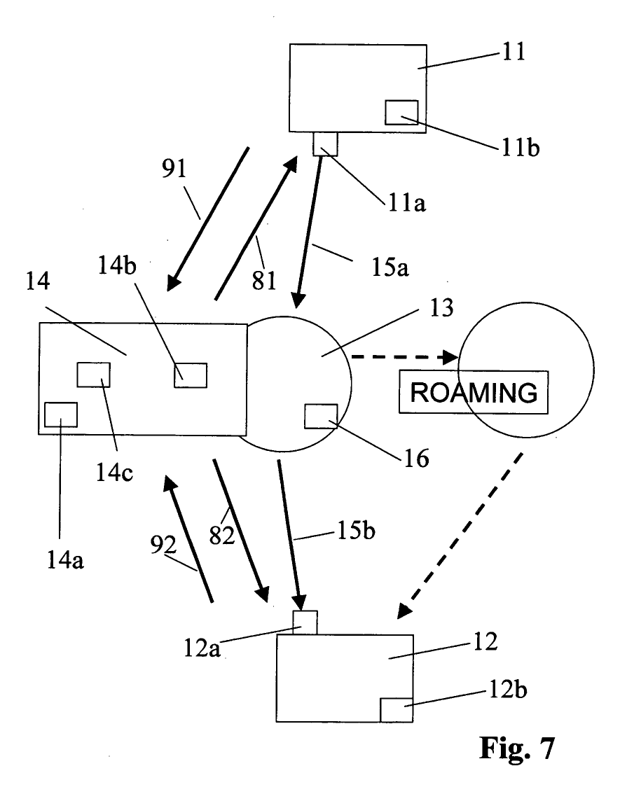

FIG. 7 schematically shows an example of a communication system according to a third preferred embodiment of the invention, with which the inventive communication method can be performed;

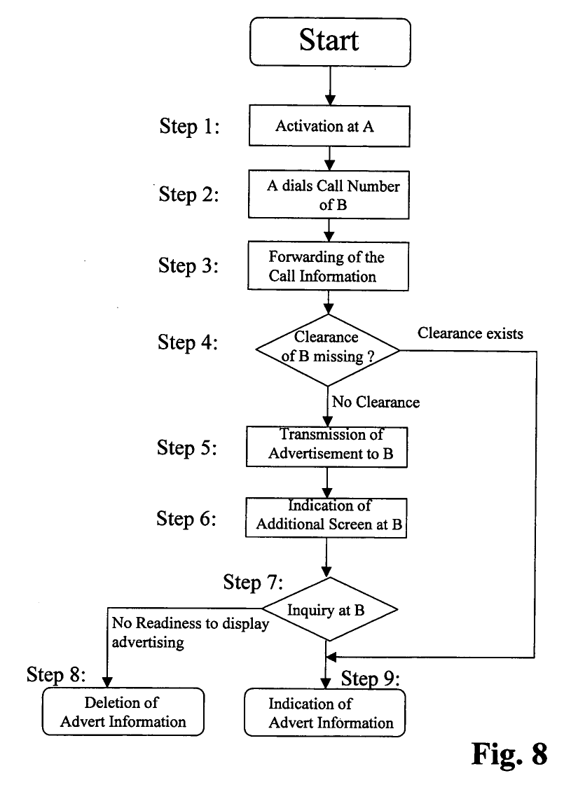

FIG. 8 schematically shows the process of an inventive communication method according to a preferred embodiment, wherein query data are sent to the recipient of the call;

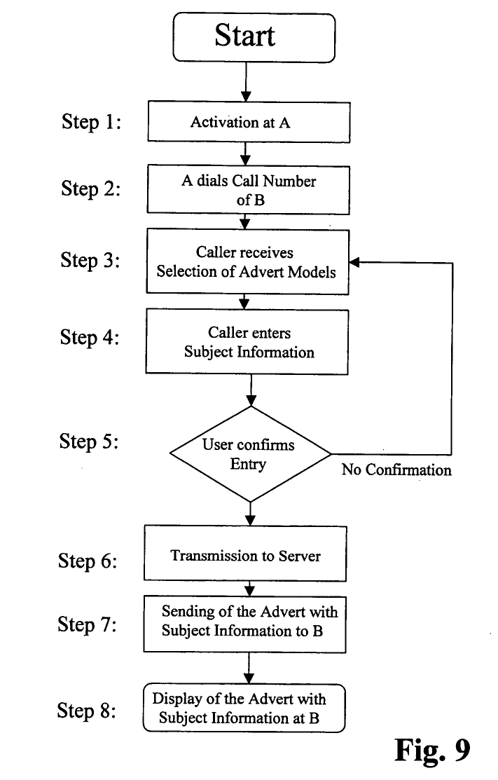

FIG. 9 schematically shows the operation process of an inventive communication method according to a further preferred embodiment of the invention, wherein query data are sent to the caller;

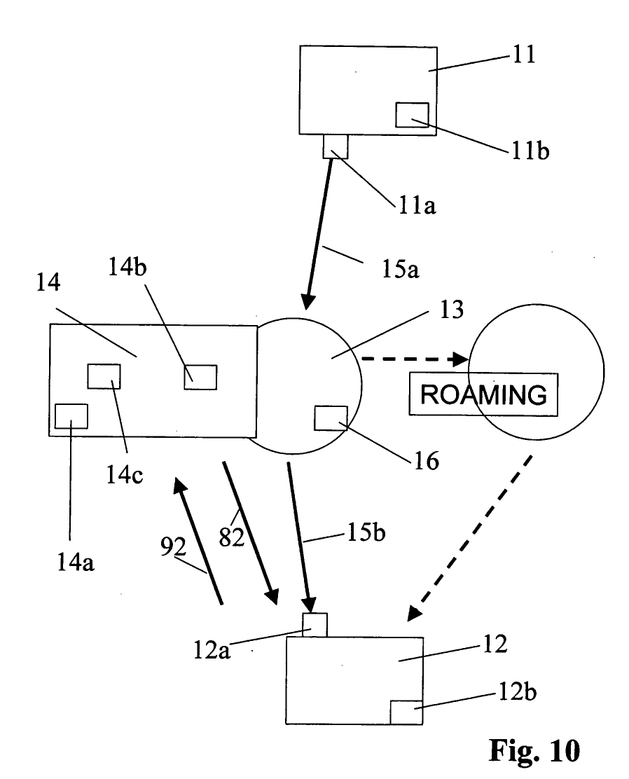

FIG. 10 schematically shows a communication system according to a fourth preferred embodiment of the invention, with which the inventive method can be performed; and

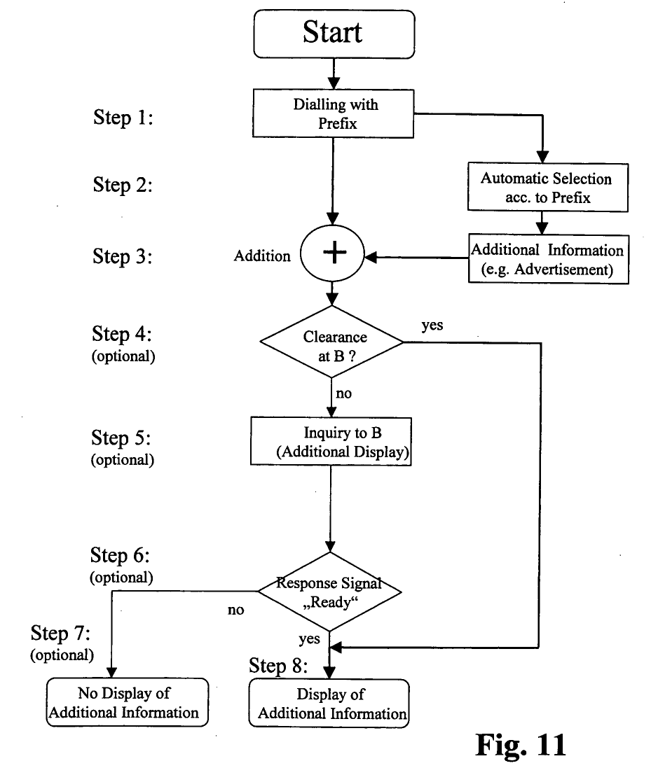

FIG. 11 schematically shows the process of an inventive communication method according to another preferred example.

Initially, a first aspect of the invention is explained in detail with reference to FIGS. 1 to 6:

FIG. 1 shows as a first example a communication system 10 to which a variety of user stations belong. For the purpose of simplification only a first user station 11 and a second user station 12 are shown respectively. The user stations 11, 12 are for example mobile telephones, PDA s, laptops, personal computers, fixed network telephones or generally any type of communication device with an interface 11a, 12a to a communication network 13.

With the help of the communication network 13, connections between the user stations 11, 12 are generated in order to transmit speech, data and in general information of different types from one to another user station or to exchange it bi-directionally. The communication network 13 is electronically coupled to an additional information device 14 and connected to it in a way, that data in the form of additional information can be added to the connection between the user stations 11, 12 by the additional information device 14.

The communication network comprises an exchange device with a switching unit 16, which generates a communication connection 15a, 15b or sets up a communication context from the first user station 11 to the second user station 12 when receiving a set-up signal i.e. a signalling for establishing a communication context.

The additional information is stored in an additional information memory 14a of the additional information device 14, whereby a variety of additional information of different types is stored in the form of data packets. The additional information comprises for example adverts, which contain multimedia data or signal image, text, speech, audio and/or video data. In an address memory, the additional information is linked to addresses or user identification numbers or codes, so that an allocation of the additional information to certain users is provided.

Further, a large number of additional information can be stored in the additional memory 14a for each user or subscriber or for each user station 11, 12, the additional information being transmitted sequentially or by chance or according to a predefined scheme to the respective user.

Each of the user stations 11,12 has a data memory 11, 12b in which different types of data, in particular text, image, audio, and/or video data or generally multimedia data can be stored. Here, the data can be stored in the form of data sets in a format, which permits a representation as individual data cards, which are referred to as ID cards hereinafter.

The single data cards or ID cards can for example contain text and images belonging thereto, and they can be linked to tone sequences, audio and/or video data. For example, a user can provide at his user station 11, 12 an ID card with a photograph of him, assign a welcome text thereto and deposit an appealing piece of music thereto. Thus, the ID card contains for example user specific information of the respective user. In the users station 11, 12, the ID cards can be loaded with the help of a processor, received, edited, stored and/or sent.

Here, a plurality of ID cards can be deposited in the respective memory 11b, 12b of the user station 11, 12 concerned. The ID cards have user numbers or user identification numbers or codes assigned thereto, which are located in the address book memory of the user station 11, 12. Thus, when calling another user, an assigned stored ID card can be sent there. However, it is also possible to provide a general ID card for transmission, which is sent to all called users, who do not have a specific individual ID card assigned.

When a communication connection 15a, 15b outgoing from the first user station 11 is set up over the communication network 13 to the second user station, the exchange device 16 of the communication network 13 checks the user identification of the called user at first, in this case of the second user station 12. This is carried out when a call set-up signal or a signalling for set-up of a communication context is received from the first user station 11.

Subsequently it will be checked whether the second user station 12 has declared its consent to receive additional information. This information is contained in a selection function. A readiness to receive additional information is normally carried out by a corresponding activation at the provider or communication service supplier.

If the clearance for the second or called user corresponding to the selection function is existent, the additional information corresponding to the user identification of the called user station 12 is called from the additional information memory 14a and sent to the second user station 12 together with the call set-up or set-up signal. For this purpose, the additional information is linked to the user identification. A coupling of the additional information to the data packet sent by the first user station 11 is performed.

If there is no existing clearance for the second or called user according to the selection function, no additional information corresponding to the user identification of the called user station 12 is called from the additional information memory 14a, and only the set-up signal is sent to the second user station 12, so that the connection between the first and the second user station 11, 12 is established without switching on or coupling additional information.

An ID card can be sent for example from the first user station 11 to the second user station 12, which ID card is already contained in the call set-up signal or in a text message or generally SMS, or coupled thereto. In any case, the ID card reaches the second user station 12, independent from the fact whether there exists a clearance for the second user station 12. The clearance is only a requirement for the dispatch and/or the generation of ID cards.

If there exists a clearance of the second user station 12, the ID card sent by the first user station 11 is indicated on the display of the second user station 12 together with the additional information, when the call or set-up signal is received there. The additional information and the ID card are alternately displayed, whereby the additional information is advantageously also provided in the ID card format.

After termination of the connection the additional information remains on the display of the second user station 12. This means that the representation of the additional information continues as long as no further call comes in. When a further call is coming in, the next following additional information can reach the user station 12 and be indicated there.

In order to facilitate the generation of ID cards, they can also be generated at another device and thereafter be loaded into the user station. In this way for example image and speech data can be loaded into the user station for example from a personal computer or by an incoming SMS, whereas text and speech data can directly be generated at the user station.

By the clearance to receive adverts, a generating function for a free of charge generation of ID cards is enabled. In this case adverts will be attached to the calls of the user by the provider or by his project partners. The call recipient at the second user station 12 alternately receives , for example in three-second intervals, the ID card of the caller and the advert. After the acceptance of the call by the second user station 12, the advert remains there on the display and changes into a screen saver after termination of the call. The screen saver remains unchanged until the next call is received.

If the ID card function is not activated, the applicant or user cannot generate own ID cards and he does not receive adverts, however he can receive ID cards of the caller.

The function can be covered globally by international roaming methods. In this case, there exists the possibility of a closed system, in which each provider or service provider connects advertising, i.e. adverts will be added to received calls of its customers. However, there exists also the possibility of an open system, in which the respective call recipient receives the advert from the provider of the caller.

In the example shown in FIG. 1, the additional information unit 14 of the network operator of the communication network 13 switches the additional information to the calls coming from the first user station 11 or onto the context set-up signals, and further transmits the call or the corresponding signal with the additional information connected to it to the second user station 12. In this case, it is also possible that the complete information reaches the second user station 12 via an operator of a foreign network 17 and a roaming connection 17a, 17b, instead of using the forwarding connection 15b within the communication network 13 of the provider.

In case of a clearance, the second user station 12 receives the caller identification of the first user station 11 as well as the ID card from the first user station 11 and the advert contained in the additional information. In this case, also own ID cards can be generated at the second user station 12 and sent from there. The service is in activated state.

In case of no existing clearance, the subscriber at the second user station 12 receives the caller identification or user identification as well as the ID card from the first user station 11, however no adverts or other additional information. In this case, no ID card can be generated and sent at the user station 12. The service is in an inactivated state.

For the purpose of clarification, the FIGS. 2a and 2b show an example for a communication system in which both user stations 11, 12 belong to the same provider.

In this context FIG. 2a shows the case that the additional information device 14 generates and connects the additional information within the communication network 13, to which the caller or the first user station 11 belongs. The advertising generated by the network operator of the caller is received at the second user station 12. Thereby the connection can be performed either directly via the communication connection 15a, 15b of the operator of the communication network 13, or via the roaming connection 17a, 17b, which is provided by the operator of the foreign network 17.

In FIG. 2b the connection runs in a similar manner via the roaming connection 17a, 17b provided by the operator of the foreign network 17. However, in this case, the additional information device 14 is part of the foreign network 17. This means that the operator of the foreign network 17 generates adverts and connects them to the call within the roaming method. The advertising generated by the roaming partner is received at the user station 12.

The FIGS. 3a and 3b show an example for a communication system, in which both user stations 11, 12 belong to different providers within the home country and domestic calls are performed.

In this context FIG. 3a shows the case that the additional information device 14 generates and adds the additional information within the communication network 13 to which the caller or the first user station 11 belongs. The advert generated by the network operator of the caller is received at the second user station 12. Thereby the connection is performed via the connection 17a, 17b provided by the operator of the foreign network 17.

In FIG. 3b the connection passes in a similar manner via the connection 17a, 17b provided by the operator of the foreign network 17. However, in this case the additional information device 14 is part of the foreign network 17 i.e., the operator of the foreign network 17 generates adverts and switches them to the call. At the user station 12, the advertising generated by the operator of the communication network of the called subscriber is received.

The FIGS. 4a, 4b and 4c show an example for a communication system in which both user stations 11, 12 belong to different domestic operators and calls are made into a foreign country.

Here, FIG. 4a shows the case that the additional information device 14 generates and adds the additional information within the communication network 13 to which the caller or the first user station 11 belongs. Via a connection 18a, the call with the advert is forwarded to the operator of the communication network 19 to which the recipient belongs. Subsequently, the call with the advert is forwarded via the connection 18b to the communication network 20 of a roaming partner, and from there it gets to the second user station 12 via the further connection 18c. There, the advert generated by the network operator of the caller is received.

In FIG. 4b the connection runs in a similar manner. However, in this case the additional information device 14 is part of the communication network 19 to which the recipient belongs. I.e., the operator of the communication network 19 generates adverts and connects them to the call. At the user station 12 the advertising generated by the operator of the communication network 19 of the called subscriber is received.

Also in figure in 4c the connection passes in a similar manner as in FIG. 4a. However, in this case the additional information device 14 is part of the communication network 20 of the roaming partner. That is, the roaming partner generates adverts and connects these messages to the call. At the user station 12 the advertising generated by the roaming partner is received.

FIG. 5 shows a communication system according to a second preferred embodiment of the invention. In this case, the first user station 11 is connected via an interface with a mobile network or communication network 31. Communication connections to a second user station 12 are generated via a further mobile network or communication network 32. The second user station 12 receives calls from the first user station 11 via the communication networks 31 and 32.

Additionally there is a connection between the communication networks 31, 32 and a global network 33, for example the Internet or an intranet. A first server station 34 within the global network 33 generates additional information, which can be for example adverts, and provides it for dispatch. When a caller signal is received from the first user station 11 in the first communication network 31, a query is sent to the server station 34 to inquire whether such additional information or data packets is/are available for adding it to the call. If this is the case, corresponding data are transmitted to a further server station 35, which belongs to the region of the recipient.

Subsequently it will be checked, whether on the side of the recipient, who is the user station 12, the selection function for receipt of additional information is activated, that is whether a corresponding clearance exists. In this case, the additional information, as for example adverts or other news in form of data, will be connected or appended to the data stream coming from the first user station 11.

In general, also in a steady state off operational stand by, that is in the ALWAYS-ON operation as for example at the wireless local area network (W-LINE), GPRS or I-MODE operational modes, additional information as for example adverts can be sent and renewed with the consent of the user even if no call is received. Thereby, for example, a free access to contents and services is achieved and the possibility of inexpensive downloads or the possibility to generate own additional information at a phone or communication receiver.

However, the main advantage according to the first aspect of the invention is, that ID cards or other data can be transmitted for free to the recipient prior to call acceptance by financing it with adverts.

The present invention couples the ring tone or the call signal or set-up signal with the reception of data, for example from the Internet or intranet. The function can be activated automatically whereby the call activates the server. In addition, an Internet/intranet data exchange or a link between different network operators is possible, which offer such kind of service.

In particular, the transmission of data or ID cards can also be coupled to the mailing of short messages or SMS. This can be done in a way that the short message or SMS is called up in the menu of the user in the known manner, whereby however the ID card of the sender and eventually alternating with it the advertising immediately appears at the display of the recipient.

Further, it is possible to send the advert with the data of a network operator. Thereby, the provider identification can be an advert, for example in the form of a screen saver, which message automatically changes in defined time intervals.

FIG. 6 schematically shows as an example the operation process and corresponding menu commands on the display of a user station 11, 12.

Via an address book command 51, an address book entry 51a with the name and the number of a user is called. By a settings command 52 an ID card can either be generated or displayed. An ID card generation command 52a serves for the generation of an ID card, whereby the ID card generation command 52a is followed by a submenu with the commands “insert text” 53, “insert image” 54 and “insert audio” 55. An ID card display command 56 serves for displaying an ID card, the ID card display command 56 having a submenu belonging thereto, which comprises the commands “delete” 57 and “edit” 58.

Via a function selection command 61, the user arrives at the commands “activate” 62 and “deactivate” 63. By this, the selection function for the receipt of advertising messages can be switched on or switched off.

Via a further settings command 64 one arrives at a submenu comprising the following commands:
65: Delete ID card for the next call;
66: Switch all ID cards on/off;
67: Use general ID card for all outgoing calls;
68: Use general ID card for all received calls without ID cards;
69: Insert ID card into address book;
70: Generate general ID card.

From the menu item 69 one arrives at the menu command 51a by which the address book entries are called up. From the menu command 70 one arrives again at the submenu 53, 54, 55 described above.

The present invention allows in particular also the generation and the free of charge dispatch of ID cards or other data packets by means of mobile radio devices. Thereby, the ID cards can be for example free designable image, text, number and/or speech data files, which are transmitted simultaneously with the caller identification or caller ID or subscriber identification to the recipient of the call. Thus, a simultaneous transmission of additional data in addition to the caller identification of mobile radio devices is possible.

By a corresponding data processing program for mobile user stations, the user can store and generate own ID cards. These ID cards can also be associated with stored numbers. A general ID card can be assigned to all numbers, which are not stored, or to stored numbers without an own ID card assigned thereto. Thereby ID cards or parts of them can be generated at a terminal device or loaded into a terminal device. An overwrite function enables for example overwriting images by text. The numeric caller identification or caller-ID is for example integrated within the ID cards. In particular, also mobile networks are suitable for processing and transmission of such data packets.

As a further advantage for the user, in addition to the possibility of a cost free generation and transmission of data packets, there is the possibility of a discount for terminal devices when a clearance is carried out, a possible cancellation of the basic fee or a reduction of the basic fee, or also a monthly subtraction of a monetary amount from the telephone bill.

Advertisers have in particular the advantage of an effective global advertising platform and a specific targeting of the advert since the advert can be connected regionally, nationally and internationally. Adverts faded in are for example adapted with respect to the language according to the country code. Further, an exact measurement for example of the number of recipients of the advertising and the duration of the advertising as screen saver when the terminal is switched on, can be carried out. These numbers can be statistically reported and the settlements of accounts can be made according to the service.

Further, a targeted advertising according to the age and sex can be performed, whereby these specifications can be made voluntary or are known from provider contracts.

A high effect of the advertising is also achieved by the fact that the screen saver at the display of the user station is seen several times by the user and the persons in his environment. Thereby an active representation is achieved for example by the mobile phone, in particular at home, in the office, in the restaurant, in a bar, etc. The acceptance is increased since the transmission of data and in particular multimedia data from and to mobile radio transmission devices corresponds to the modern spirit of the times.

Operators benefit in particular from the possibility of an additional income by the provision of an advertising platform, the connection with the UMTS usage, corresponding advantages in the competition and a platform for new own services and for services of third parties.

In addition there exists the possibility to overwrite or replace ring tones by music, audio or speech messages. In the case of collisions between data indications, corresponding overwrite functions can be provided, which set a priority function of particular indications depending on the clearance.

In the following, a second aspect of the invention is described with reference to FIGS. 7 to 9:

FIG. 7 shows a communication system 200 with an exchange device according to a further embodiment of the invention. To the communication system 200 belong a variety of user stations, whereby only a first user station and a second user station 12 are shown herein for the purpose of a simplified representation. The user stations 11, 12 are for example mobile radio devices, PDAs, laptops, personal computers, fixed network telephones or generally any kind of communication device with an interface 11a, 12a to a communication network 13.

The communication system 200 with the communication network 13 comprises an exchange device 16, which generates a communication connection 15a, 15b or a communication context from the first user station 11 to the second user station 12 when receiving a call set-up signal, that is a signal for setting up a communication context or a set-up signal. With the help of the communication network 13, connections between the user station 11, 12 are established in order to transmit or bi-directionally exchange speech, data or generally information of different types from one to another user station.

The communication network 13 is electronically coupled to an additional information device 14 and connected with it in a way, that data in form of additional information from the additional information device 14 can be switched to the communication connection 15a, 15b between the user stations 11,12, or additionally transmitted to the second user station 12 within the context of the communication connection 15b.

The additional information is stored in an additional information memory 14a of the additional information device 14, whereby a large number of different additional information in form of data packets is deposited. The additional information comprises for example adverts, which comprise multimedia data or in general data as for example image, text, speech, audio and/or video data.

Further, a query unit 14b for sending query data 81, 82 to the first user station 11 and/or to the second user station 12 is provided. A selection circuit 14c serves to effect the transmission of additional information depending on the response signal 91, 92 of the respective user station 11, 12.

According to a particularly advantageous example of the inventive method, the query data 82 is sent to the second user station 12 in order to ask whether the recipient of the call at the second user station 12 wants to see further information to the current call. In this case, the selection circuit 14c serves to send or not to send the further information there, depending on the response signal 92 of the second user station 12. Thus, the response signal 92 contains information on whether further information is to be indicated at the second user station 12. If this is not the case, only basis data or information or only a first part of the information of the first user station 11 will be transmitted to the second user station 12.

However, if the response signal 92 of the second user station 12 contains the message, that further information or additional information is to be indicated, the selection circuit 14c effects the transmission of additional information from the additional information device 14 to the second user station 12.

For example, one or more adverts added as additional information is displayed at the second user station 12, alternating with additional data or other additional information sent by the first user station 11. This additional information may comprise for example image, video, speech, text, audio or other data sent from the first user station 11, which data are preferably displayable or displayed in the form of a data card or ID card on a display of the second user station 12. In this case, the information supplements such basis data or information, which normally is displayed without the addition of additional information or adverts. Thus, if desired by the users, complete multimedia data sets of the first user station 11 are displayed or not displayed at the second user station 12 in the form of ID cards alternating with adverts from the additional information device 14.

The inventive communication method can also be used when transmitting SMS or MMS messages. In this case, the message or SMS/MMS message is composed at the first user station 11 and sent to the second user station 12. The query unit 14b of the exchange device of the communication network 13 subsequently sends the query data 82 to the user station 12 to inquire whether advertising is to be displayed there. If confirmed by the second user station 12 with the response signal 92, the advertising is received there and displayed as additional information in addition to the SMS or MMS message.

The indication of the advert is for example performed alternately with the indication of the SMS or MMS message, or also prior to it during a defined period of time. In return for the readiness to additionally display advertising, the subscriber receives particular benefits, which are stored as benefit data in a benefit memory assigned to the user. These benefits are for example a reduction of the communication costs, bonus points, free units, the possibility to transmit and receive ID cards, etc.

These benefits may be granted to the first user station 11 or the caller as well as to the second user station 12 or the recipient of the call, and collected in a memory, which is assigned to the respective user. In particular, with the query data 82, the recipient of the call can be informed about the fact that the caller at the first user station will receive a charge benefit or another advantage if the readiness to display additional information is confirmed by the recipient of the call. The advantages can also be offered to the recipient of the call by the query data 82.

For the purpose of clarification, FIG. 8 schematically shows the process of the inventive communication method according to the described example. Initially, the caller A activates at the first user station 11 (see FIG. 7) the possibility to send a personal data card or ID card (step 1). Then the caller A selects the call number of the subscriber B at the second user station 12 (step 2). Then, the call information is forwarded to the additional information device 14 (step 3). There it will be checked at first, whether the second user station 12 is activated to receive advertising (step 4).

If a clearance exists, an additional information in the form of an advert is immediately indicated at the second user station 12 for example in alternation with the multimedia ID card sent by the first user station 11 (step 9). If a clearance for advertising is missing, the query data 82 (see FIG. 7) is transmitted from the additional information device 14 to the second user station 12 (step 5). Thereby the query data are displayed at the second user station 12 on a display indication, which is additionally provided (step 6).

Now, the inquiry with respect to the readiness for displaying advertising information at the second user station 12 takes place, which can be responded there by a corresponding entry (step 7). For example it is asked, whether the user or subscriber B wants to see the ID card of the caller A and an additional advertising. If there is no readiness, a negative response signal 92 is sent to the additional information device 14 and no additional information in form of adverts is displayed. The advert is deleted or suppressed (step 8). However, if the readiness to receive advertising information exists, it will be displayed on the display of the second user station 12, for example alternating with the multimedia ID card sent from the first user station 11 (step 9).

By this communication method the subscribers can be addressed directly and also motivated to participate in an ID card exchange system in return for the receipt of advertising. The costs for the transmission of large data, multimedia data and particular ID cards can be reduced considerably.

With reference to the communication system 200 shown in FIG. 7, the inventive communication method according to another preferred example will be explained in the following.

There, the query data 81 are sent to the first user station 11 in order to offer there a selection of different advertising models or additional information models, from which a particular model can be selected at the first user station 11, in order to transmit it to the second user station 12 as an additional information.

The additional information model selected at the first user station 11 is communicated with the response signal 91 from the first user station 11 to the additional information device 14, and subsequently transmitted from there to the second user station 12. Thus, additional information selected by the caller, which comprises for example an advertising selected by the caller, is displayed at the second user station 12 in addition to the information of the first user station 11.

The additional information models selectable at the first user station 11 are provided with an entry field in which the caller may enter his personal messages, so that in this case the personal messages of the caller within the entry field are linked with the additional information. In this case, the additional information or advert selected by the caller is displayed at the second user station 12 together with a personal text of the caller.

The additional information provided with a personal comment or with a subject information of the caller is for example displayed in alternation with the data transmitted from the first use station 11. These are for example personal multimedia data or ID cards, which are sent from the first user station 11 to the second user station 12. Thus, a caller can send his ID cards at low costs or even for free, because they are displayed at the recipient or the second user station 12 together or alternating with an advertising, which is personalised by the caller.

FIG. 9 schematically shows the process of the inventive communication method according to this described example, for the purpose of further clarification.

Initially, a caller A activates at the first user station 11 (see FIG. 7) the transmission of data, for example multimedia data in the form of an ID card (step 1). The caller A selects the call number of a user B at the second user station 12 (step 2). Now, the caller A receives from the additional information device 14 a selection of advertising models, each of them having a subject entry field (step 3). The caller A enters the subject information into the given field (step 4). Subsequently, the caller A confirms his entry (step 5). If there is no confirmation, a new selection is possible, that is, return to step 3.

Then, the selected advertising model or information on it with the personal subject information is transmitted together with the response signal 91 to the additional information device 14, which is e.g. designed as a server (step 6). Now the advertising is transmitted with the subject information to the user B or the second user station 12 (step 7). There the advertising is displayed together with the subject information at user B (step 8).

Because the caller selects the additional advert himself and personalises it, that is, he may add a personal message or a recommendation to it, the dissemination loss of advertising is considerably reduced. The advert is positively perceived and the danger of an advertising, which is perceived as bothering is reduced. Concurrently, the users can exchange multimedia data or other information, at least partly financed by advertising. In particular, personal address data packets, which are for example provided with images or other multimedia data, can be exchanged and displayed as ID cards, whereby the costs for the user can be largely reduced.

The additional information is for example coupled to addresses or user identification numbers or codes within an address memory, so that there is an assignment of the additional information to specific users.

Each of the users station 11, 12 has a data memory 11b, 12b, in which different data, in particular text, image, audio and/or video data or generally multimedia data can be stored. There, the data may be deposited in the form of data sets in a format, which allows an indication as an individual data card or ID card.

The single data cards or ID cards can for example contain text and images belonging thereto, and they can be linked with tone sequences, audio and/or video data. A user can for example at his user station 11, 12 deposit an ID card with a picture of him, add a welcome text to the picture and deposit an appealing piece of music thereto. In the user station 11, 12, ID cards can be loaded, received, edited, stored and/sent by means of the processor.

Thereby a large number of ID cards can be deposited in the respective memory 11b, 12b of each user station 11, 12. The ID cards are assigned to user numbers or user identification numbers or codes, which are located in the address book memory of the user station 11, 12. Thus, when another subscriber is called, a respective stored ID card assigned to him can be sent there. However, also a general ID card can be supplied for dispatch, which general ID card is sent to all called users who have no special individual ID card assigned.

In order to facilitate the generation of ID cards, they can also be generated at another device and thereafter loaded into the user station. By this, in particular image or speech data can for example be loaded from a personal computer or via incoming short messages (SMS) or MMS into the user station, whereas text and speech data are for example generated directly at the user station.

By the declaration of readiness to receive adverts, also a generating function for free of charge generation of ID cards can be activated for example. In this case, the provider or his project partners append adverts to the calls of the user. The call recipient at the second user station 12 alternately receives, for example in three-second intervals, the ID card of the caller and the advert, provided that he has declared by his response signal his readiness for this. After acceptance of the call by the second user station 12, the advert remains there at the display and mutates to a screen saver after termination of the call. This screen saver remains unchanged until the next call is coming in.

The function can be globally covered by an international roaming method. In this context exists the possibility of a closed system, in which each provider or service supplier sends query data and additionally connects advertising, that is, calls of his customers are for example provided with query data and adverts are added thereto. However, there exists also the possibility of an open system, in which the respective recipient of a call receives the advert and/or the query data 81, 82 from the provider of the caller.

With reference to FIGS. 10 and 11, a third aspect of the invention is described in the following:

FIG. 10 shows a communication system 300 with an exchange device according to a further preferred embodiment of the invention. To the communication system 300 belong a large number of user stations, whereby for the purpose of simplification only a first user station 11 and a second user station 12 are shown here. The user stations 11, 12 are for example mobile radio devices or mobile phones, PDAs, laptops, personal computer, fixed network telephones, and in general any kind of communication device having an interface 11a, 12a to a communication network 13.

Each of the user stations is provided with a memory 11b, 12b in which the data of users with assigned numbers or call identifications are stored.

The communication system 300 comprises an exchange device 16, which, when receiving a call set-up signal or signal for set-up of a communication context from the first user station 11, generates a communication connection 15a, 15b or a communication context to the second user station 12. By means of the communication network 13, connections between the user stations 11, 12 are established, in order to transmit or bi-directionally exchange speech, data, and in general information of very different types from one to another user station.

The communication network 13 is electronically coupled to an additional information device 14 and connected with it in a way, that data in form of additional information can be switched to the communication connection 15a, 15b between the user stations 11, 12 by the additional information device 14, or can be transmitted additionally to the second user station 12 in the context of the communication connection 15b.

The additional information is stored in an additional information memory 14a of the additional information device 14, wherein a large number of different additional information in form of data packets is deposited. The additional information stored within the additional information device 14 comprises a large number of adverts and a plurality of general information, but also individual information of single users, which were generated by the user and/or selected from models and deposited for sending it to other users.

A selection circuit 14c serves to effect the transmission of additional information to the second user station 12, depending on an additional or prefix code which was dialled by the first user station 11 together with or prior to the call identification. Thereby the additional information is transmitted to the second user station 12 by the communication connection 15b within the call set-up signal or set-up signal for the communication context.

The additional information comprises data such as image, text, audio and/or video data and in general multimedia data. The data are stored and can be sent in an accurately defined data format so that they can be displayed as electronic data cards or ID cards on the displays of the user stations. That is, the recipient of an ID card sees on his display graphical information or image or video information, which may contain additional text and/or which is linked with audio signals.

However, it is also possible that not only the additional information contain multimedia data for example in the format of the ID cards, but also the information sent by the first user station is available in the ID card format and displayed when received.

Furthermore, according to a particular embodiment, a query unit 14b for sending query data 82 to the second user station 12 is provided within the additional information device 14. In this case, the query data 82 can be sent to the second user station 12 in order to inquire, whether the call recipient at the second user station 12 would like to see further information in addition to the current call. In this case, the selection circuit 14c additionally has the purpose, either to send the further information there or not, depending on the response signal 92 from the second user station 12. Thus, the response signal 92 contains information on whether further information or additional information is to be indicated at the second user station 12. If this is not the case, only basic data or information or only a first part of the information is transmitted to the second user station 12, or only the information sent from the first user station 11 is transmitted to the second user station 12.

However, if the response signal 92 from the second user station 12 contains the message, that further information or additional information is to be displayed, then the selection circuit 14c effects the transmission of additional information from the additional information device 14 to the second user station 12.

The information of the caller and the additional information is transmitted via one or more switching stations with the known roaming methods, as it is shown by the dashed line in FIG. 10.

For the purpose of clarification, FIG. 11 schematically shows the process of the inventive communication method by means of a further preferred example. Initially, a caller dials at the first user station 11 a particular prefix or code prior to the call number of the second user 12. This is done either by an entry on the keyboard or by retrieving an entry of the electronic telephone directory of the first user station 11 from the memory 11b. There, predefined, different prefixes can already be assigned to particular telephone directory entries of other user stations.

The prefixes or codes are known to the users of the communication service for example from SMS or MMS messages or short messages, or by products provided with a corresponding prefix. The prefixes can also made known to the users by the adverts, cinema and TV spots, and they can be linked with particular advantages when they are selected.

Due to dialling the code or prefix prior to the call number of the second user station 12, the corresponding prefix code or additional code is transmitted to the additional information device 14 together with the call identification of the second user station 12.

The selection circuit 14c selects according to the prefix code or additional code defined additional information from a large number of stored additional information. This additional information is for example an advert or a personal message of the caller, which he has previously deposited. The additional information is added so that it is directly contained within the call set-up signal, which is sent to the second user station 12 for signalling the call. Thereby the additional information, which is available for example in the form of advertising, can be selected according to the personal profile of the recipient of the call.

In a next step it is checked whether the recipient of the call at the second user station is ready to accept the additional information. This can be done either by a previous clearance of the second user station to receive additional information, or by an active inquiry directly before the respective call. In this case, the query unit 14b initially sends query data 82 to the second user station12. Depending on the response signal 92 of the second user station 12 in response to the query data, the transmission of the additional information to the second user station is permitted or prevented.

The examination of the readiness to accept additional information is optional, that is, the method can also be performed without that test. In case that the first user station 11 causes the transmission of advertising as additional information to the second user station 12 through the prefix or additional number, the additional information is personalised or a personal message from the caller, in order to point at particular products, services, films, restaurants or other subjects, which the recipient of the call will probably like to accept as information, or which will show his cellular phone in a representative manner leading to an improved image of the user.

In return for the readiness to additionally display advertising or for the use of the additional or pre-number during a call, the one or more users 11, 12 or participants receive particular advantages which are stored in a benefit memory assigned to the respective user as benefit data. These advantages are for example a price reduction of the communication costs, bonus points, free units, the possibility to transmit or to receive ID cards, etc. The bonus points can also be redeemed later by means of a terminal or a user station.

These benefits may be granted to the first user station 11 or the caller as well as to the second user station 12 or the call recipient. In particular, with the query data 82 the call recipient can be informed that the caller at the first user station 11 or the recipient of the call himself receives a charge benefit or another benefit if the readiness to display additional information is confirmed by the call recipient at the user station 12.

If at the second user station 12 the readiness for receipt of additional information is existent, one or more adverts added as additional information are transmitted within the call set-up signal to the second user station 12, for example. There they will already be displayed when the call set-up signal is received. That is, during an incoming call, adverts are displayed as pop-up on the display of the second user station 12. In return, the caller at the first user station 11 and/or the call recipient at the second user station 12 receive one or more bonus points, which can be redeemed for example by means of mobile phone.

The additional information is displayed at the second user station 12, for example alternately with additional data or other data sent from the first user station 11. This additional information may in particular comprise image, video, speech, text, audio or other data sent form the first user station 11, which data are preferably displayed or can be displayed on the display of the second user station 12 in the form of a data card or ID card. In this case, for example complete multimedia data sets of the first user station 11 are displayed at the second user station 12 in the form of ID cards, alternating with adverts of the additional information device 14, which are also available in the format of ID cards.

The inventive communication method can also be performed when SMS or MMS messages are transmitted. In this case, the message or SMS/MMS message is compiled at the first user station 11 and sent to the second user station 12, wherein during dialling the prefix or additional number is also dialled. If the readiness to receive additional information exists, the additional information, for example advertising, is received there and displayed in addition to the SMS or MMS message.

Thus, by the present invention a number of advantages are achieved:

A caller may send multimedia data as electronic data cards to other users or participants in a simple manner, without the necessity of having special terminal devices. Further, callers may individually select additional information, which they want to send to the recipient. The additional information can be own multimedia electronic business cards or data cards or ID cards of the caller, which cards will represent him on the display of the recipient already when the call is coming in.

The call recipient has the advantage, that he receives visual information related to the content of the call before he accepts the call. However, the additional information may also comprise general information or adverts, which, when transmitted, grant charge benefits or other advantages to the users, as for example the use of particular services or communication connections.

The network operator receives the benefit of an increased demand for modern communication services due to the attractiveness and the possibility of financing it through advertising, and that available capacities are used and can be further expanded. When adverts are transmitted, a settlement of invoices can be made according to client contacts.

Companies and advertising agencies receive the advantage, that target group specific marketing can be performed in a simple way. Adverts can be placed specifically according to interests and user profiles, and the advertising may take place through further recommendation of the costumers.

The different aspects of the invention result in a number of advantages. They can be combined with each other, that is, the features can supplement each other according to the specific requirements of the respective application.

1. Method for the transmission of additional information in a communication system (10;30;200;300), wherein a communication context (15a, 15b; 15a, 17a, 17b; 17a; 18a, 18b, 18c) is established from a first user station (11) to at least to a second user station (12) for transmitting information or data to the second user station (12), and depending on a set-up signal from the first user station (11) for setting up the communication context, additional information is transmitted from an additional information device (14; 34, 35) to the second user station (12), characterized in that the data of the first user station (11) and/or the additional information is transmitted to the second user station (12) within the set-up signal for setting up the communication context in a predefined format in order to permit there a representation as a data card with text and image content before the call is accepted.

2-39. (canceled)
